(19) United States
(12) Patent Application Publication
(10) Pub. No.: US 2018/0036663 A1
(43) Pub. Date: Feb. 8, 2018

(54) PARTICLE SEPARATOR

(71) Applicant: Hanon Systems, Daejeon (KR)

(72) Inventors: Ayhan Ayar, Koln (DE); Jacek Gerhard Bennek, Koln (DE); Hendrik Langenberg, Koln (DE)

(21) Appl. No.: 15/666,304

(22) Filed: Aug. 1, 2017

(30) Foreign Application Priority Data
Aug. 2, 2016 (DE) 102016114263.8

(51) Int. Cl. B01D 35/14; B01D 29/90

(52) U.S. Cl. CPC B01D 35/14; B01D 29/90

(57) ABSTRACT

A particle separator for the separation of solid particles out of a flowing fluid, the input mass flow, which is characterized in that a particle chamber for concentrating the solid particles to be separated is disposed in the flow path of the input mass flow and that at least one region of the wall of the particle chamber is implemented as a filter element through which a primary mass flow of the fluid can flow and that, additionally, at least one bypass opening is disposed in the wall of the particle chamber for the through-flow of the fluid with a secondary mass flow at higher filtration resistance.

The invention relates very generally to a particle separator for separating solid particles out of flowing fluids.

A particular application field of the invention is the utilization of the particle separator according to the invention for purifying partial flows, such as control and lubrication mass flows, of mobile refrigerant compressors. In particular in the case of wobble plate, captive C washer and scroll compressors as well as electric scroll compressors, a partial flow of the refrigerant-oil mixture is utilized for lubrication, or control, which can be freed of solid particles using the particle separator.

It is known that especially mobile refrigerant compressors include an internal refrigerant circuit for lubricating the compressor mechanism and for the purpose of compressor control. This circuit is also referred to as control mass flow. This control mass flow is frequently enriched with oil and contains solid particles suspended in it. The mixture of refrigerant, oil and particles of the control mass flow is conducted from the high-pressure side across a throttle element into the crank case of the compressor and subsequently conducted across a further throttle element out of the crank case to the suction side of the compressor.

On the high-pressure side path, as a rule, an electronic control valve is disposed and on the low-pressure side path a throttle. Converse applications and configurations as well as configurations with two throttles, thus one throttle on the high-pressure side and one throttle on the low-pressure side, matched in terms of diameters, are also known. In each case the control valve as well also the throttle is equipped with filters or screens in order to protect them against undesirable particles and to ensure the function of the valves and of the compressor. Solid particles can here either be fabrication residues of the compressor or of the entire refrigerant system or be generated in the form of abrasion or wear particles through the operation of the compressor during its service life.

Too strong a loading of the filters with solid particles leads to undesirable effects. For one, too high a pressure loss can be generated in the filter which affects the controllability of the compressor and narrows the operation range.

For another, the filters becoming clogged can block the internal control mass flow entirely and prevent the oil supply to the mechanism that requires continuous lubrication. In this case failure of the compressor threatens due to inadequate lubrication.

This problem is frequently addressed in prior art thereby that the filter surface is enlarged in order to prevent the clogging of the filter surface.

However, the available installation space, and therewith also the available filter surface, is limited especially when using the compressors in the field of mobile refrigeration engineering, for example for motor vehicle air conditioning systems.

A further disadvantage in prior art is the changing particle loading of the filter over its service life and entailed therein a changing pressure loss and flow through the filter. The function of the compressor consequently also changes over its service life. The filter can also become completely clogged which can lead to the failure of the compressor.

The invention therefore addresses the problem of ensuring an extension of the service life of the filter with the least functional restrictions and, moreover, to prevent the complete clogging of the filter with the interruption of the fluid flow at the greatest possible reliability and certainty of the absence of solid particles in flowing fluids.

The problem is resolved through a subject matter with the characteristics according to patent claim 1. Further developments are specified in the dependent patent claims.

The problem is in particular resolved through a particle separator for separating solid particles from a flowing fluid, the input mass flow, wherein a particle chamber is disposed in the flow path of the input mass flow in order to concentrate the solid particles to be separated out. At least one region of the particle chamber wall is herein implemented as a filter element for the through-flow of a primary mass flow of the fluid.

In addition, at least one bypass opening is disposed in the particle chamber wall for the through-flow of the fluid with a secondary mass flow at higher filtration resistance.

The flowing fluid with the solid particles enters the particle separator as the input mass flow. The fluid flowing through the filter leaves the particle separator as a primary mass flow, while the fluid flowing across the bypass leaves the particle separator as a secondary mass flow. According to the concept, the implementation of the secondary mass flow takes place such that at an increase of the pressure loss due to the filter becoming clogged with solid particles, starting at a specific and predeterminable higher filtration resistance, the fluid flows through a bypass opening and forms a secondary mass flow which virtually represents a minimum mass flow that prevents the total failure of the compressor when the particle separator is employed for purifying the control mass flow of a compressor control. As a result, the functional reliability of the entire system of a refrigeration system can be achieved through the particle separator.

The flow and through-flow parameters of the particle separator are alternatively implemented such that the bypass does not limit the mass flow but rather, even in the case of a completely clogged filter, allows the full quantity of the control mass flow to flow through. The particle separator is fluidically so dimensioned, for example, that with a particle-free filter a portion of the mass flow can always flow through the bypass and a portion of the mass flow flows through the filter material. Of advantage is herein that in the portion of the control mass flow that flows through the filter, the particles in the filter are effectively immobilized and that in the case of a completely clogged filter, the requisite full control mass flow can flow through the bypass.

According to a preferred implementation of the invention, a nozzle is disposed in the flow path of the fluid in front of the particle chamber whereby in the particle separator initially an increase in the speed of the flowing fluid and subsequently a speed reduction of the flowing fluid is enabled and, entailed therein, improved separation of solid particles from the flowing fluid.

According to a preferred implementation, the geometry of the nozzle is implemented such that its cross section and/or length is/are adjustable through an additional nozzle element. The nozzle element in an especially preferred implementation extends the length of the nozzle through-flow of the fluid.

An annular implementation of the nozzle is a further advantageous implementation of the nozzle in which the input mass flow of the fluid into the particle chamber is therewith realized as an annular coaxial flow.

According to an especially advantageous implementation of the invention, the particle chamber is at least partially delimited by a deflector plate, wherein the deflector plate prevents the solid particles from leaving the particle chamber during the flow with the secondary mass flow.

Within the scope of the invention, by deflector plate is understood a baffle plate which is functionally located in the flow path of the fluid in secondary flow and which, through the impact of the solid particles on the deflector or baffle plate, absorbs their kinetic energy and slows down the particles such that they deposit out of the secondary mass flow and can be concentrated in the particle chamber.

According to an alternative implementation of the invention, the particle chamber is realized as a hollow cylinder, wherein the filter element is developed as a portion of the cylinder wall and the input mass flow enters the particle chamber axially and the primary mass flow exits the particle chamber in the radial direction, wherein the particle chamber has a greater through-flow cross section than the inflow tube of the particle separator through which the input mass flow flows thereinto. The particle chamber comprises furthermore in the axial direction a front wall and a rear wall.

The one or several bypass openings of the particle separator in the axial direction are, again, advantageously disposed in the rear wall of the particle chamber and developed as a gap between the inflow tube and the wall of the particle chamber.

Especially preferred is a settling chamber disposed in the flow path of the secondary mass flow past the particle chamber and the bypass opening.

For a further deposition effect, a labyrinth element is advantageously disposed in the settling chamber, which functionally forces a flow reversal of the secondary mass flow and therewith realizes an increased deposition effect for solid particles out of this secondary mass flow.

According to an especially advantageous implementation of the invention, the particle separator, or more specifically the particle chamber, is developed as a component of the compressor shaft of a refrigerant compressor.

The particle separator advantageously includes a rotationally symmetric hollow-cylindrical casing in which an inset is disposed that compartmentalizes the interior volume of the casing.

It is especially preferred for the walls of the particle chamber to be implemented entirely as filter element.

An advantageous application of the particle separator is its use in refrigerant-oil circuits of refrigeration systems or heat pumps.

It is especially preferred to use the particle separator in a control mass flow of a refrigerant compressor.

In summary, the concept of the invention comprises that in order to achieve controllability and lubrication of the compressor over its entire service life, instead of a filter a particle separator is proposed as a particle trap in the control mass flow. The particle trap is to some extent implemented as a filter and, to ensure the through-flow at full particle loading, comprises a bypass.

According to one implementation of the invention the solution comprises an element which conducts, and initially accelerates, the control mass flow and the particles contained therein. Acceleration takes place due to the constriction of the flow cross section for the input mass flow through a nozzle. Due to the mass inertia of the solid particles, they assume a different movement direction in comparison to the refrigerant-oil mixture. Consequently, the solid particles can be selectively directed into a trap element. To augment the trap effect and to minimize turbulences which could drive the particles out again, the trap element is produced of a filtration material. This filtering material can be of the most diverse structure and composition, applicable and employable are for example metallic filter materials, sintered filters, felt-like materials in a support structure, or porous metallic materials and other filtering materials.

A portion of the refrigerant-oil mixture can pass the filter material as the primary mass flow, while the particles are retained in the filter. According to the concept, the particle trap comprises furthermore a bypass which, according to one implementation of the invention, is separated by a baffle plate from the particle chamber. The function of the bypass assumes increasing importance the fuller the particle chamber is loaded with particles and the filter therewith becoming less permeable. Consequently, a greater pressure drop occurs across the filter with the pressure increasing in front of the filter. In this case the particles are continued to be hurled into the particle chamber due to mass inertia, wherein, however, a secondary mass flow through the bypass forms which, in the event of complete closure of the filter, flows out of the particle separator as a minimum control mass flow. An optionally provided baffle plate, also referred to as deflector plate, prevents the entrainment of particles in the secondary mass flow out of the particle chamber into the bypass. The form of the baffle plate is herein selected such that a discharge of particles into the bypass is minimized.

In an implementation variant, the baffle plate has, for example, at its outer diameter a T-shaped end whereby particles entrained by the bypass impact against the T-form and arrive back in the particle chamber. Consequently, even at high particle loading, constant pressure loss and minimum through-flow through the particle separator is ensured.

According to a special implementation variant, the nozzle geometry, the constriction site of the inflow, can be varied in its length in order to conduct the flow longer and therewith to affect the outflow direction out of the nozzle into the particle chamber.

According to an alternative implementation variant without nozzle, the inflow of the fluid, the input mass flow, is introduced through a central feed line, the inflow tube, into the particle chamber. The entrance of the inflow is located centrally in the particle chamber.

Due to the greater volume of the chamber in comparison to the inflow tube, the flow is decelerated such that the particles can settle. The particle chamber is also produced of a filter material. Either the entire chamber can, again, be comprised of filter material or only the external mantle surface. As in the previously described implementation variant, the trap element comprises a bypass which becomes effective when the filter surfaces are clogged by particles.

This implementation can especially advantageously be housed in a rotating component of the compressor, for example in the compressor shaft. In this case the particles entering the particle chamber are pressed by the centrifugal force onto the outer surfaces of the trap and are retained there. The bypass is implemented as a gap between the inflow tube and the casing and is located as far removed as feasible from the inflow opening, and placed as centrally as possible, in order to have the greatest distance from the particle-trapping surface. The gap is implemented as small as possible. In the rotating variant a further settling chamber can be implemented in which residual particles from the bypass flow, the secondary mass flow, are trapped. Alternatively, in the settling chamber a labyrinth can also be constructed in order to deposit additionally solid particles.

The advantages of the described invention are manifold. With the invention it becomes feasible to free a fluid flow of solid particles with high reliability and certainty and simultaneously to ensure a minimum throughflow.

In a preferred application field of the particle separator mechanically sensitive components, for example a downstream refrigerant compressor or valves, are permanently protected against particles. In the application for purification of a control mass flow, additionally, by providing a secondary mass flow, the capacity to function continues independently of the filter loading even in the event the filter is completely clogged.

Advantageous is furthermore the low installation space for implementing the particle separator in connection with the significant increase of the reliability of the compressor in the above described application.

The operational reliability and the service life of the overall system and of the individual components can be improved and extended through the particle separator according to the concept.

Further details, characteristics and advantages of implementations of the invention are evident based on the following description of embodiment examples with reference to the associated drawing. Therein show:

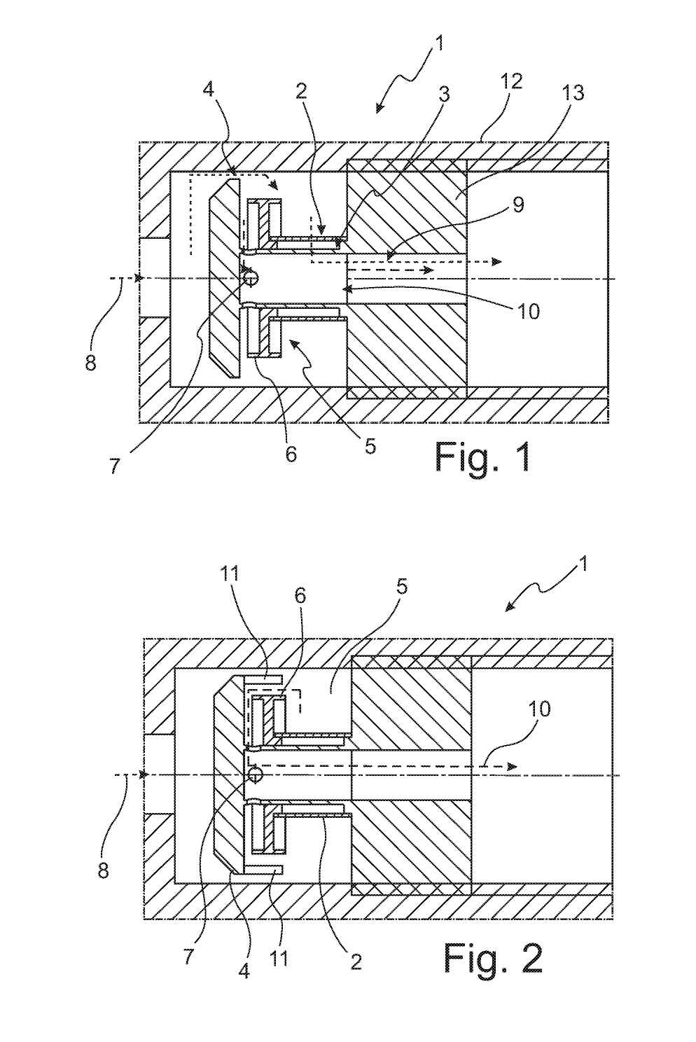

FIG. 1: particle separator with nozzle in cross sectional representation,

FIG. 2: particle separator with nozzle and additional nozzle element in cross sectional representation,

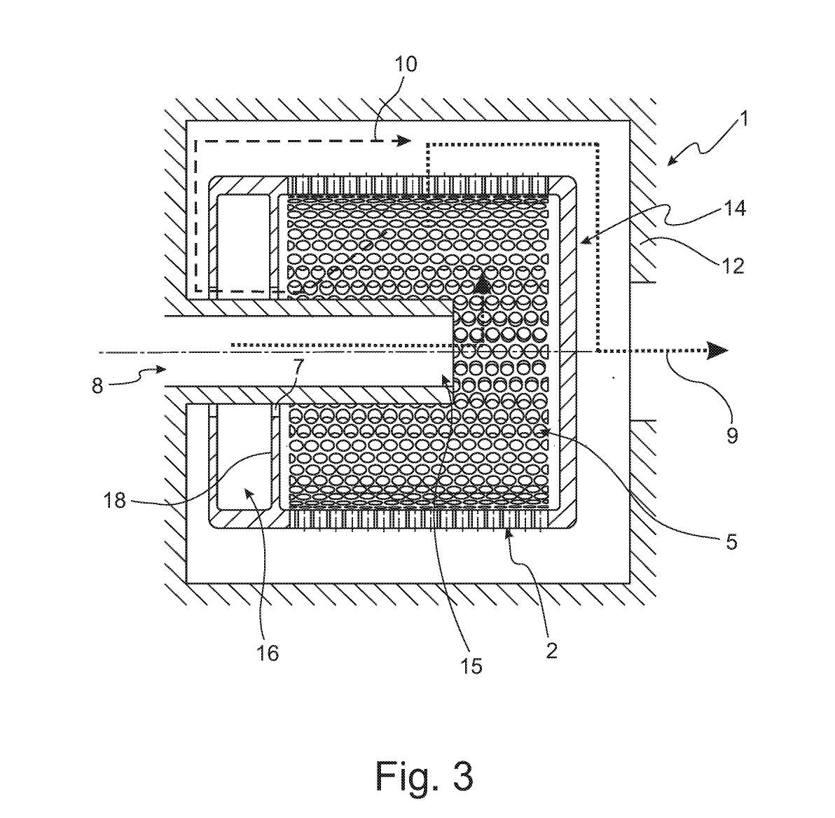

FIG. 3 particle separator with central and axial inflow to the particle chamber in cross sectional representation,

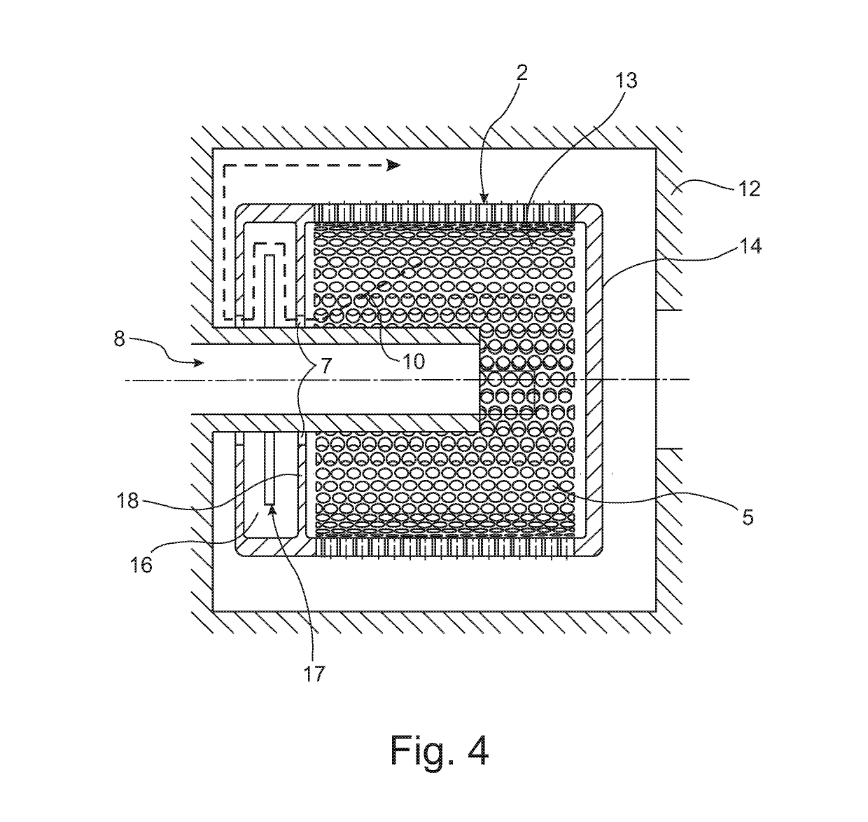

FIG. 4 particle separator with settling chamber and labyrinth element.

In FIG. 1 is depicted a first embodiment of a particle separator 1 in cross section utilized in a refrigerant circuit. The embodiment comprises a filter element 2 as well as a filter retainer 3 permeable for the filtrate, which retains and supports the filter element 2 in its position. Furthermore is provided a nozzle 4 which lastly forms a flow constriction site for the input mass flow 8. The nozzle 4 is here implemented annularly as a coaxial gap such that a coaxial flow develops with respect to the input mass flow 8 entering the particle separator 1. The fluid flowing through the nozzle 4 is accelerated and, past the nozzle 4, decelerated again, wherein, due to inertia, the solid particles from the input mass flow 8 slow their movement with delay and arrive thus in the particle chamber 5 after the nozzle 4 and are here concentrated. The fluid with the solid particles is now filtered in the particle chamber 5 by filter element 2, with the solid particles being retained on the filter element 2. The filter element 2 is developed as a portion of the wall of the particle chamber 5 and the filtrate, the largely particle-free refrigerant-oil mixture, reaches as the so-called primary mass flow 9 through a central region of the inset 13 the outlet of the particle separator 1. If the filter element 2, due to a concentration of solid particles thereon, becomes impaired in its permeability and an increased pressure drop develops, the fluid is no longer going to flow through the filter 2 but rather will flow out of the particle chamber 5 on another path and therein make contact with the deflector plate 6. The deflector plate 6 causes the solid particles, contained in the fluid flow flowing from the particle chamber 5, to flow against the deflector plate 6, rebound therefrom and lose their kinetic energy. Consequently, the major portion of the solid particles remains in the particle chamber 5. The fluid flowing out of the particle chamber 5 forms the secondary mass flow 10, also referred to as bypass mass flow, and flows through the bypass opening 7, of which there are preferably several, to the outlet of the particle separator 1. With increasing pressure loss, due to the blocking of the filter 2, an output mass flow of the fluid of the two partial mass flows forms in a transition phase before the filter 2 is completely blocked. The output mass flow is composed of the weakening primary mass flow 9 and the secondary mass flow 10. With the complete blocking of filter element 2 the output mass flow is entirely comprised of the secondary mass flow 10 and, with the filter element 2 entirely free of particles, the output mass flow is formed nearly exclusively by the primary mass flow 9.

According to the present embodiment, the structure of the particle separator 1 is formed by a cylindrical casing 12 which includes an inlet and an outlet at opposite end sides. In the casing 12 is disposed an inset 13 which holds the filter element 2 in a certain region and forms here the filter retainer 3. The inset 13 is furthermore developed at its inlet-side end by an annular plate which, implemented correspondingly to the cylindrical casing wall at an appropriate distance, forms the nozzle 4 at the narrowest site. In terms of fabrication engineering the particle separator 1 can in this way especially advantageously be produced cost effectively of essentially one casing element and one inset element.

The particle separator 1 according to FIG. 2 is developed further such that the geometry of the nozzle 4 is changed through an additional nozzle element 11. It has been found that through an additional, and optionally adjustable, nozzle element 11, the flow and pressure relationship in the nozzle as well as also the conduction of the fluid as an annular flow coaxially to the particle chamber 5 can be optimized. In the depicted embodiment the secondary mass flow 10 flows through between the deflector plate 6 and the nozzle element, passes the bypass 7 and subsequently reaches the outlet of the particle separator 1.

FIG. 3 and FIG. 4, alternatively to the embodiment according to FIG. 1 and FIG. 2, depict particle separators 1 which do not require the additional acceleration of the fluid in front of the particle chamber 5 and consequently dispense with a nozzle and a nozzle element. A further significant difference of the last-mentioned embodiments consists therein that the filter element 2 is implemented as a component part of a cylindrical particle chamber 5 and the primary mass flow 9 leaves the particle chamber 5 outwardly in the radial direction. With the rotating implementation of the particle separator 1 the centrifugal force becomes hereby usable as the driving force for the filtration.

The input mass flow 8 is moved across an inflow tube 15 axially and centrally into the particle chamber 5. In the transition from the inflow tube 15 to the particle chamber 5, the flow cross section widens for the input mass flow 8 such that a slowing of the flow occurs and the particles are already concentrated in the particle chamber 5 matrix through which it flows. In the axial direction the particle chamber 5 is delimited by a front wall 14 and a rear wall 18. The mechanism of function of the embodiment depicted in FIG. 3 and FIG. 4 is similar to the mechanism of function of the embodiment according to FIG. 1 and FIG. 2, wherein with each increase of the pressure drop through the filter element 2 a secondary mass flow 10 is generated in the particle chamber 5. This secondary mass flow 10 does not flow through the filter 2 but rather through a bypass opening 7 in the form of a gap on the rear wall 18 into a settling chamber 16. In the settling chamber 16 solid particles are again deposited before the secondary mass flow 10 flows to the outlet of the particle separator 1. The casing 12 encompasses the particle chamber 5 and the flow paths for the primary mass flow 9 and the secondary mass flow 10.

In addition to the components and elements of the embodiment according to FIG. 3, in the embodiment according to FIG. 4 labyrinth elements 17 are disposed in the settling chamber 16 which additionally affect the flow of the secondary mass flow 10 and are intended to lead to a deposition of solid particles out of the secondary mass flow 10.

### LIST OF REFERENCE NUMBERS

1 Particle separator
2 Filter element
3 Filter retainer
4 Nozzle, flow constriction
5 Particle chamber
6 Deflector plate, baffle plate
7 Bypass opening
8 Input mass flow
9 Primary mass flow, filtrate
10 Secondary mass flow, bypass mass flow
11 Nozzle element
12 Casing
13 Inset
14 Front wall
15 Inflow tube
16 Settling chamber
17 Labyrinth element
18 Rear wall

1. A particle separator for the separation of solid particles from a flowing fluid, the input mass flow, wherein a particle chamber for the concentration of the solid particles to be separated is disposed in the flow path of the input mass flow, wherein at least one region of the wall of the particle chamber is implemented as a filter element for a primary mass flow of the fluid to flow through, and wherein additionally at least one bypass opening is located in the wall of the particle chamber for the through-flow of the fluid with a secondary mass flow.

2. A particle separator as in claim 1, wherein in the flow path of the fluid a nozzle is disposed in front of the particle chamber.

3. A particle separator as in claim 2, wherein the geometry of the nozzle can be implemented such that its cross section or length are adjustable through a nozzle element.

4. A particle separator according to claim 2, wherein the nozzle is implemented annularly and the input mass flow into the particle chamber is developed as a coaxial flow.

5. A particle separator according to 1, wherein the particle chamber is at least partially delimited by a deflector plate, and wherein the deflector plate prevents the solid particles from leaving the particle chamber during the flow with the secondary mass flow.

6. A particle separator as in claim 1, wherein the particle chamber is implemented as a hollow cylinder, wherein the filter element is implemented as a portion of the cylinder wall and the input mass flow enters the particle chamber axially and the primary mass flow leaves the particle chamber in the radial direction, wherein the particle chamber has a greater through-flow cross section than an inflow tube of the particle separator.

7. A particle separator as in claim 6, wherein one or several bypass openings are disposed in the axial direction in the particle chamber and are implemented as a gap between the inflow tube and the wall of the particle chamber.

8. A particle separator according to claim 6, wherein a settling chamber is disposed in the flow path of the fluid past the particle chamber and the bypass opening.

9. A particle separator as in claim 8, wherein in the settling chamber a labyrinth element is disposed.

10. A particle separator according to claim 6, wherein the particle chamber is implemented as a component of the compressor shaft of a refrigerant compressor.

11. A particle separator according to claim 1, wherein the particle separator comprises a rotationally symmetric hollow cylinder-shaped casing in which an inset is disposed that compartmentalizes the interior volume of the casing.

12. A particle separator according to claim 1, wherein the walls of the particle chamber are entirely implemented as a filter element.

13. A refrigeration system or heat pump comprising a refrigerant oil circuit, said refrigerant oil circuit comprising a particle separator according to claim 1.

14. A wobble plate compressor comprising a control mass flow and a particle separator.

15. A particle separator according to claim 7, wherein a settling chamber is disposed in the flow path of the fluid past the particle chamber and the bypass opening.

16. A particle separator according to claim 2, wherein the particle separator comprises a rotationally symmetric hollow cylinder-shaped casing in which an inset is disposed that compartmentalizes the interior volume of the casing.

17. A particle separator according to claim 3, wherein the particle separator comprises a rotationally symmetric hollow cylinder-shaped casing in which an inset is disposed that compartmentalizes the interior volume of the casing.

18. A particle separator according to claim 4, wherein the particle separator comprises a rotationally symmetric hollow cylinder-shaped casing in which an inset is disposed that compartmentalizes the interior volume of the casing.

19. A particle separator according to claim 5, wherein the particle separator comprises a rotationally symmetric hollow cylinder-shaped casing in which an inset is disposed that compartmentalizes the interior volume of the casing.

20. A particle separator according to claim 6, wherein the particle separator comprises a rotationally symmetric hollow cylinder-shaped casing in which an inset is disposed that compartmentalizes the interior volume of the casing.
